(19) United States
(12) Patent Application Publication
(10) Pub. No.: US 2013/0312919 A1
(43) Pub. Date: Nov. 28, 2013

(54) SCROLLING UNIT FOR CORDLESS BLINDS

(71) Applicants: Sheng Ying Hsu, Changhua County (TW); Wu-Chung Nien, Changhua County (TW)

(72) Inventors: Sheng Ying Hsu, Changhua County (TW); Wu-Chung Nien, Changhua County (TW)

(73) Assignee: CHING FENG HOME FASHIONS CO., LTD, CHANGHUA COUNTY (TW)

(21) Appl. No.: 13/617,835

(22) Filed: Sep. 14, 2012

(30) Foreign Application Priority Data
May 22, 2012 (TW) 101209611

(51) Int. Cl. E06B 9/322; E06B 9/30

(52) U.S. Cl. 160/170

(57) ABSTRACT

A scrolling unit for blinds includes a scrolling unit having a main wheel, at least one sub wheel and a scrolling spring. The main wheel has a spool and a cable is wrapped to the spool. The scrolling spring has an inner end and an outer end. The inner end is securely wrapped to the main wheel and the outer end is wrapped to the at least one sub wheel. The scrolling force of the inner end is larger than that of the outer end. The cable is wrapped to a mandrel unit in the head box. The cable extends through the head box and is connected to the bottom bar. The blinds are connected between the head box and the bottom bar to which the cable is fixed. The bottom bar is cooperated with the scrolling spring regardless the weight of the bottom bar.

### FIELD OF THE INVENTION

The present invention relates to a scrolling unit for cordless blinds, and more particularly, to a scrolling unit effectively scroll the operation cables.

### BACKGROUND OF THE INVENTION

The conventional scrolling unit for cordless blinds generally comprises a scrolling unit, a mandrel unit, a head box, a curtain unit and a bottom bar. The scrolling unit has a scrolling spring received therein, and the elasticity coefficient of the inner end of the scrolling spring is the same as that of the outer end of the scrolling spring. The scrolling unit and the mandrel unit are located in the head box. The cables of the scrolling unit wrap the mandrel unit and then extend through the head box and the slats and then fixed to the bottom bar. The connection cords for connecting the slats extend through the bottom bar and are fixed to the head box. By lifting or lowering the bottom bar, the blinds are lifted or lowered.

However, because the elasticity coefficient of the inner end of the scrolling spring is the same as that of the outer end of the scrolling spring, the bottom bar is equipped with weights and the scrolling spring has to be cooperated with the weights of the bottom bar. This makes the manufacture of the blinds be complicated.

Furthermore, the blinds tend to moved upward after the user release the bottom bar, if the scrolling spring is not properly set relative to the weight of the bottom bar. In other words, the conventional scrolling unit cannot precisely set the blinds at desired position.

The present invention intends to provide a scrolling unit for blinds and the scrolling unit of the present invention improves the shortcomings of the conventional scrolling unit.

### SUMMARY OF THE INVENTION

The present invention relates to a scrolling unit for blinds and comprises a scrolling unit having a main wheel, at least one sub wheel and a scrolling spring. The main wheel has a spool and a cable is wrapped to the spool. The main wheel and the at least one sub wheel are pivotably connected in the scrolling unit. The scrolling spring has an inner end and an outer end, wherein the inner end is securely wrapped to the main wheel and the outer end is wrapped to the at least one sub wheel in the direction that is opposite to the direction that the inner end is wrapped to the main wheel. The scrolling force of the inner end is larger than that of the outer end. A mandrel unit is located adjacent to the scrolling unit and the cable is wrapped to the mandrel unit. A head box has a bottom board connected to an underside thereof and the bottom board has multiple guide holes. The cable extends through the guide hole. The blinds have at least two connection cords, multiple slats and a bottom bar. The slats have passages. The at least two connection cords are fixed to the bottom bar. The cable extends through the passages and is connected to the bottom bar. The at least two connection cords are fixed to the bottom bard. The bottom board of the head box has multiple fixing holes, and the at least two connection cords extend through the fixing holes and are secured to the fixing holes.

The bottom bar is operated upward or downward to lift or lower the blinds. Because the scrolling force of the inner end is larger than that of the outer end, the cable is effectively scrolled regardless the weight of the bottom bar so that the manufacturing cost is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the blinds with the scrolling unit of the present invention;

FIG. 2 shows that the blinds are collected to the upper position;

FIG. 3 shows the partial side cross sectional view of the blinds with the scrolling unit of the present invention;

FIG. 4 is a partial front cross sectional view of the blinds with the scrolling unit of the present invention;

FIG. 5 is the scrolling unit of the present invention;

FIG. 6 shows the scrolling spring of the present invention;

FIG. 7 shows that the scrolling spring is extended;

FIG. 8 is the curve showing the relationship between the force and the length that the scrolling spring extends, and

FIG. 9 shows that the blinds are pulled downward by pulling the bottom bar.

### DETAILED DESCRIPTION OF THE PREFERRED EMBODIMENT

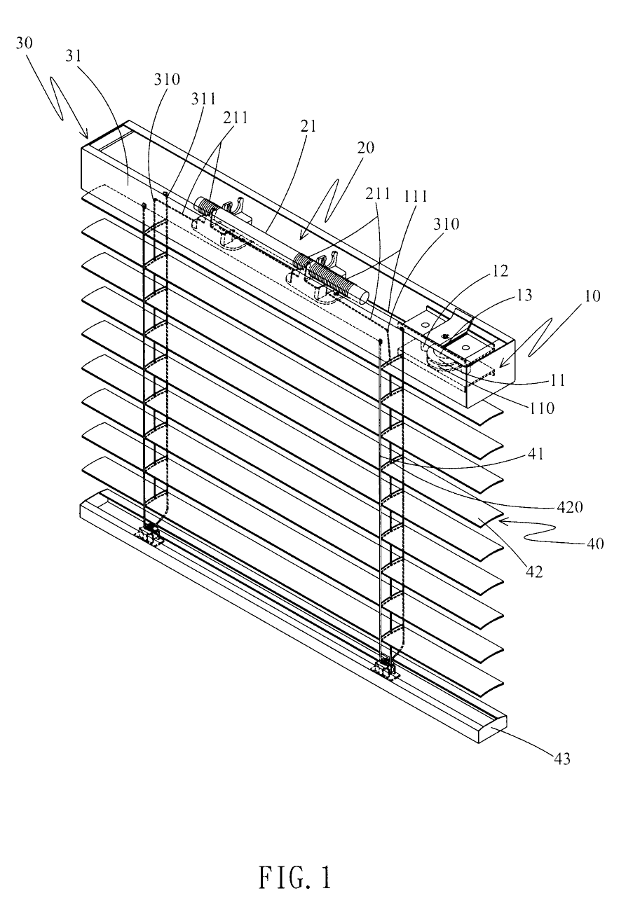

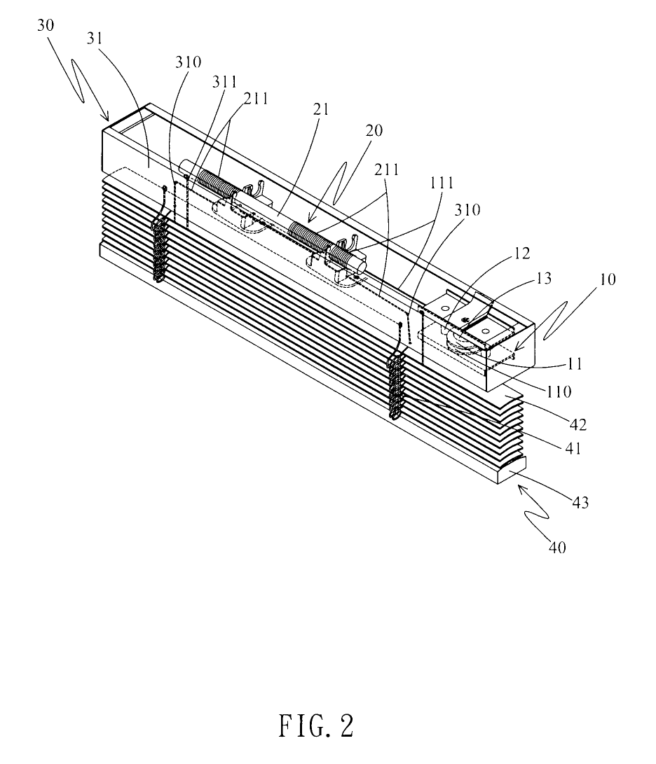

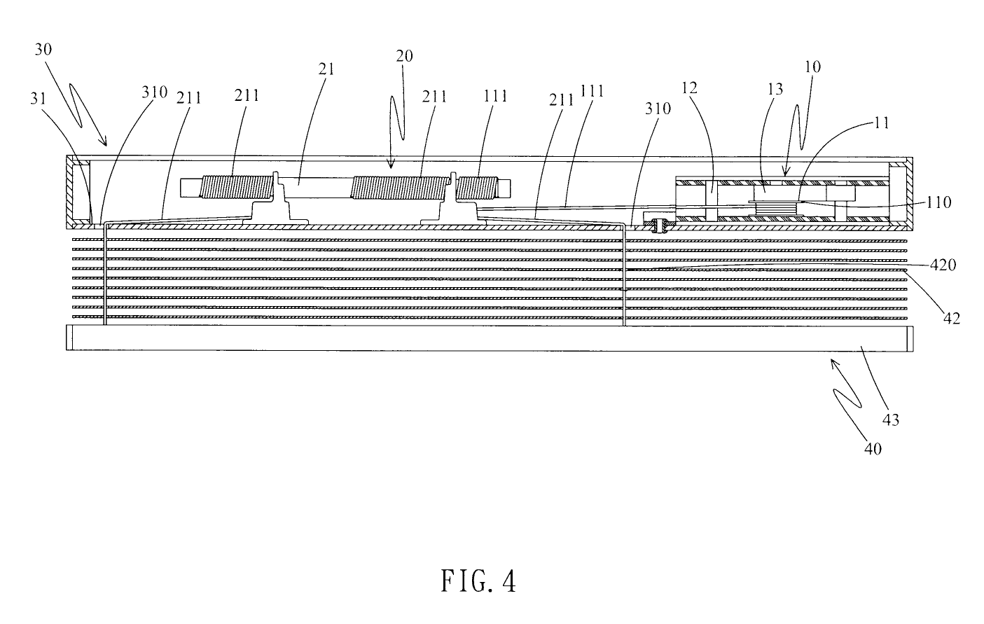

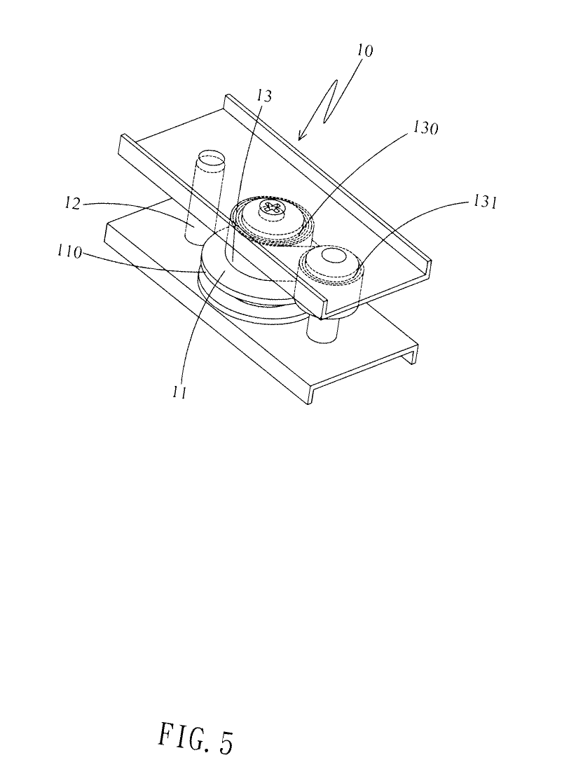

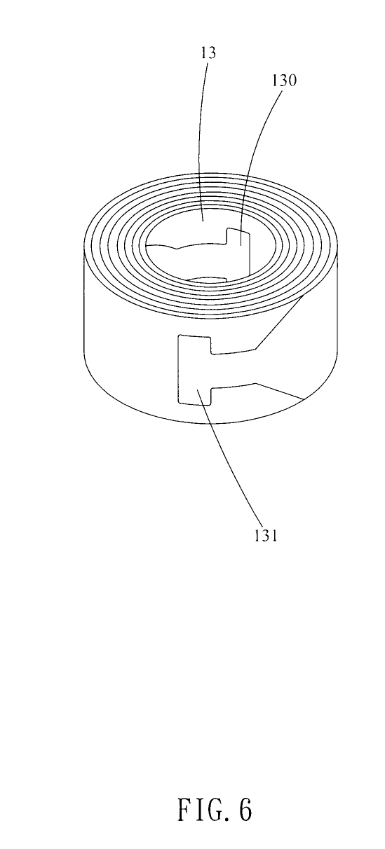

Referring to FIGS. 1 to 6, the scrolling unit for the blinds of the present invention comprises a scrolling unit 10 having a main wheel 11, at least one sub wheel 12 and a scrolling spring 13. The main wheel 11 has a spool 110 and a cable 111 is wrapped to the spool 110. The main wheel 11 and the at least one sub wheel 12 are pivotably connected in the scrolling unit 10. The scrolling spring 13 has an inner end 130 and an outer end 131, wherein the inner end 130 is securely wrapped to the main wheel 11 and the outer end 131 is wrapped to the at least one sub wheel 12 in the direction that is opposite to the direction that the inner end 130 is wrapped to the main wheel 11. The scrolling force of the inner end 130 is larger than that of the outer end 131.

A mandrel unit 20 is located beside the scrolling unit 10 and the cable 111 is wrapped to the mandrel unit 20.

A head box 30 has a bottom board 31 connected to the underside thereof and the bottom board 31 has multiple guide holes 310 and multiple fixing holes 311. The bottom board 31 allows the scrolling unit 10 and the mandrel unit 20 to be secured in the head box 30. The cable 11 extends through the guide hole 310.

The blinds 40 have at least two connection cords 41, multiple slats 42 and a bottom bar 43. The slats 42 have passages 420. The lower ends of the at least two connection cords 41 are fixed to the bottom bar 43. The slats 42 are located between the at least two connection cords 41. The cable 111 extends through the passages 420 and is connected to the bottom bar 43. The upper ends of the at least two connection cords 41 extend through the fixing holes 311 and are secured to the fixing holes 311 of the bottom board 31.

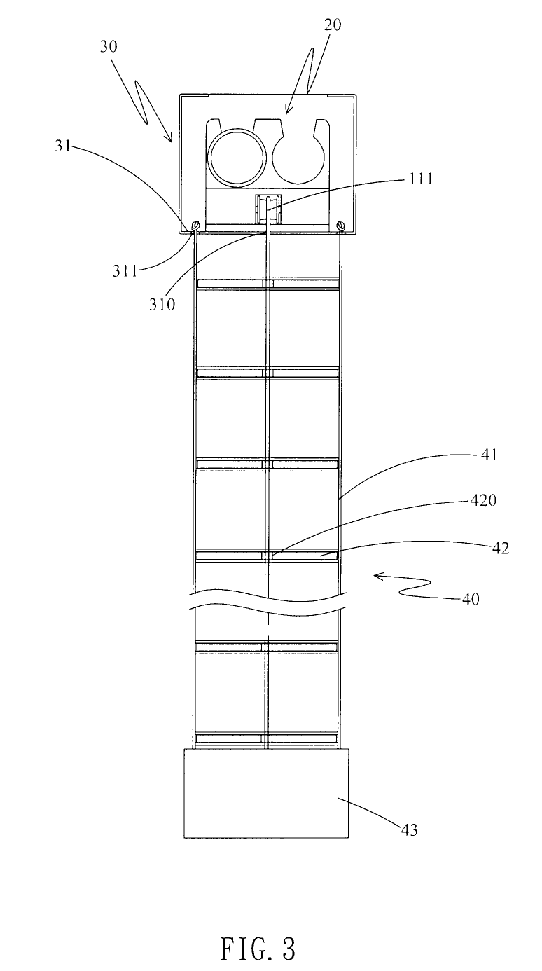

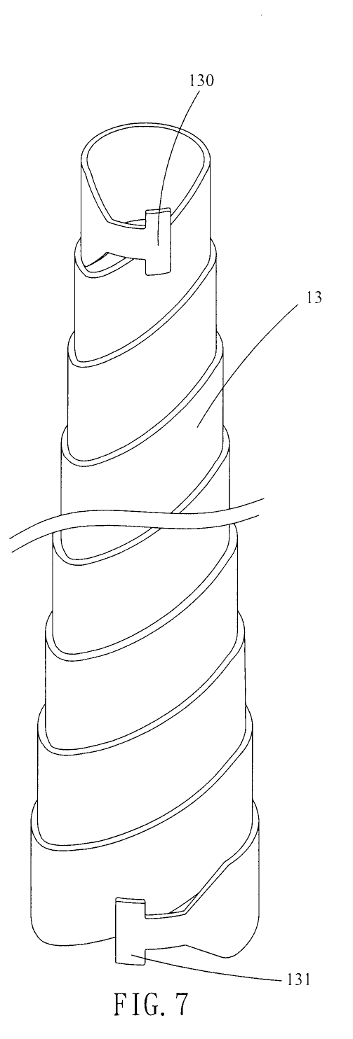

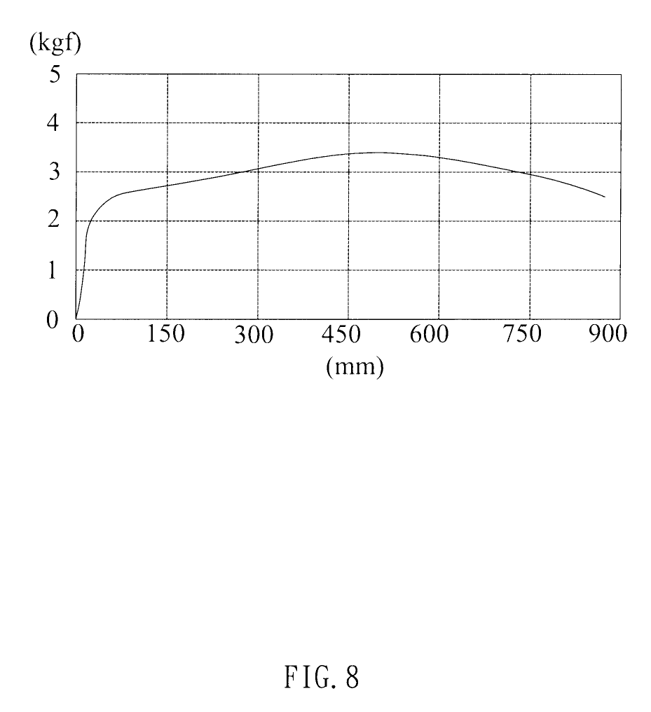

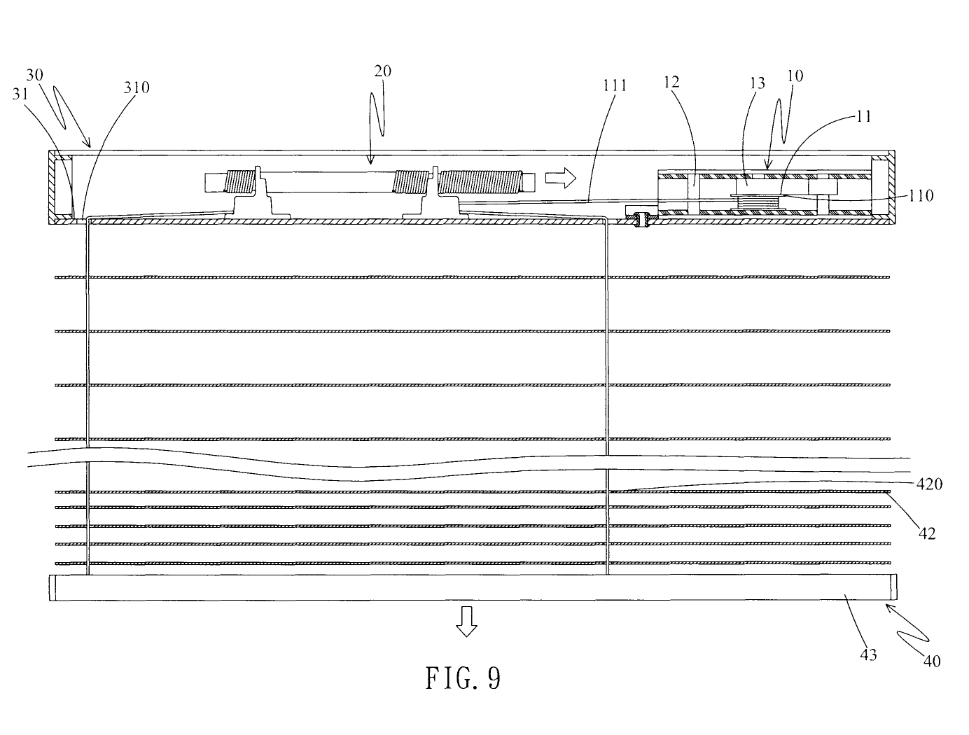

Referring to FIGS. 3 to 9, the scrolling force of the inner end 130 is larger than that of the outer end 131, and this can be referenced from the FIGS. 7 and 8. When the user operates the bottom bar 43 upward and downward, the scrolling unit 10 and the mandrel unit 20 are activated to control the movement of the blinds 40. Thanks to the fact that the scrolling force of the inner end 130 is larger than that of the outer end 131, the bottom bar 43 does not need to be equipped with weights and the blinds 40 are precisely lifted or lowered. Once the bottom bar 43 is released, the blinds 40 is set its position without worry of pulled upward.

The present invention has the advantage that the bottom bar 43 does not need to be equipped with weights and the blinds 40 are precisely lifted or lowered. This is made by the fact that the scrolling force of the inner end 130 is larger than that of the outer end 131.

While we have shown and described the embodiment in accordance with the present invention, it should be clear to those skilled in the art that further embodiments may be made without departing from the scope of the present invention.

What is claimed is:

1. A scrolling unit for blinds, comprising:
a scrolling unit having a main wheel, at least one sub wheel and a scrolling spring, the main wheel having a spool and a cable wrapped to the spool, the main wheel and the at least one sub wheel pivotably connected in the scrolling unit, the scrolling spring having an inner end and an outer end, the inner end securely wrapped to the main wheel and the outer end being wrapped to the at least one sub wheel in a direction that is opposite to a direction that the inner end is wrapped to the main wheel, a scrolling force of the inner end being larger than that of the outer end;
a mandrel unit and the cable wrapped to the mandrel unit;
a head box having a bottom board connected to an underside thereof and the bottom board having multiple guide holes, the cable extending through the guide hole, and
a set of blinds having at least two connection cords, multiple slats and a bottom bar, the slats having passages, the at least two connection cords fixed to the bottom bar, the cable extending through the passages and connected to the bottom bar, the at least two connection cords fixed to the bottom bard.

2. The scrolling unit as claimed in claim 1, wherein the bottom board of the head box has multiple fixing holes, the at least two connection cords extend through the fixing holes and are secured to the fixing holes.
